(19) United States
(12) Patent Application Publication
(10) Pub. No.: US 2014/0318946 A1
(43) Pub. Date: Oct. 30, 2014

(54) Apparatus and Method for Reducing Viscosity

(71) Applicant: Save The World Air, Inc., Santa Barbara, CA (US)

(72) Inventors: Bjorn D. H. Simundson, Santa Barbara, CA (US); Carl D. Meinhart, Santa Barbara, CA (US)

(73) Assignee: Save The World Air, Inc., Santa Barbara, CA (US)

(21) Appl. No.: 14/263,203

(22) Filed: Apr. 28, 2014

Related U.S. Application Data
(60) Provisional application No. 61/816,884, filed on Apr. 29, 2013.

(51) Int. Cl. B01J 19/08

(52) U.S. Cl. CPC B01J 19/088
USPC 204/168; 422/186.04

(57) ABSTRACT

An apparatus for reducing viscosity of a hydrocarbon liquid containing paraffin molecules or asphaltene molecules in suspension. The apparatus includes a conduit having an inner cavity dimensioned to accommodate a flow of the hydrocarbon liquid along a flow direction, and a series of electrically charged plates housed within the inner cavity with a longitudinal axis of each plate extending along the flow direction. A method of reducing viscosity of a hydrocarbon liquid containing paraffin molecules or asphaltene molecules in suspension, the method including flowing the hydrocarbon liquid through the inner cavity of a conduit and applying an electric field to the hydrocarbon liquid flowing through the inner cavity such that a plurality of paraffin molecules or a plurality of asphaltene molecules undergo a conformational change in microstructure to form a cluster of paraffin molecules or a cluster of asphaltene molecules, thereby reducing the viscosity of the hydrocarbon liquid.

### CROSS-REFERENCE TO RELATED APPLICATION

This application claims the benefit of and priority to U.S. Provisional Patent Application No. 61/816,884, filed Apr. 29, 2013, which is incorporated herein by reference.

### BACKGROUND OF THE INVENTION

This invention relates to an apparatus and method for reducing viscosity in fluids. More specifically, but not by way of limitation, this invention relates to an apparatus and method for reducing viscosity in hydrocarbon liquids and gas.

### SUMMARY OF THE INVENTION

A method of reducing viscosity of a hydrocarbon liquid, with the hydrocarbon liquid containing in suspension paraffin molecules and/or asphaltene molecules. The method comprises providing the liquid in a conduit, flowing the liquid through the conduit, and applying an electric field to the liquid. The method includes creating a cluster of paraffin molecules resulting from conformational change in the microstructure and/or creating a cluster of asphaltene molecules resulting from conformational change in the microstructure, thereby reducing the viscosity of the hydrocarbon liquid. In one embodiment, the hydrocarbon liquid is crude oil.

In one embodiment, the step of applying the electric field comprises flowing the crude oil through a series of electrically charged plates and/or concentric cylinders positioned within the conduit, wherein the plates and/or concentric cylinders may be arranged parallel to flow (see FIGS. 3, 4, 5 and 6). Also, the step of applying the electric field may comprise varying the length of time of the applied electric field. Additionally, the step of applying the electric field may comprise varying the strength of the applied electric field.

### BRIEF DESCRIPTION OF THE FIGURES

FIG. 1 is an illustration of a paraffin molecule.

FIG. 2 is an illustration of an asphaltene molecule.

FIGS. 3 and 4 are illustrations of one embodiment of the parallel plate apparatus.

FIG. 5 is an illustration of the concentric ring apparatus compared to the parallel plate apparatus.

FIG. 6 is a 3D extrusion of the concentric ring apparatus compared to the parallel plate apparatus.

FIG. 7 is an illustration of a paraffin molecule with an induced dipole region.

FIGS. 8A-8C illustrate the aggregation process for paraffin-like molecules.

### DETAILED DESCRIPTION OF THE EMBODIMENTS

This disclosure describes the physical mechanisms by which viscosity can be reduced in hydrocarbons (e.g., crude oil) containing paraffin and/or asphaltenes. In this disclosure, two specific types of molecular aggregation are described: paraffin-based and asphaltene-based.

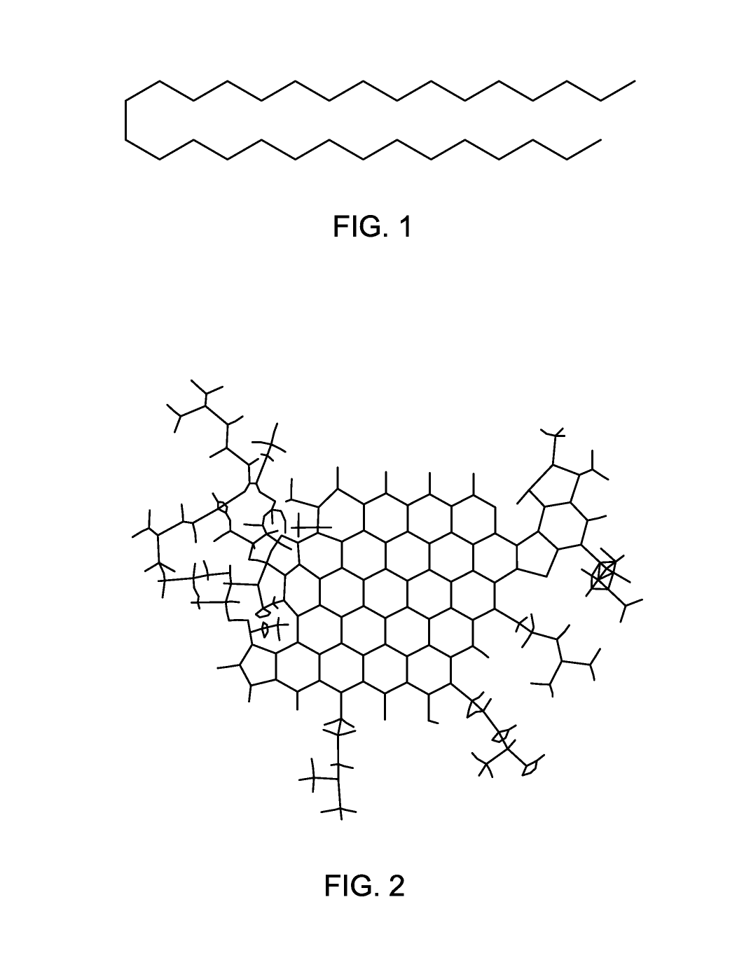

Paraffin molecules are typically considered to be long alkane molecules. One example of such molecules is shown in FIG. 1.

For sufficiently low temperatures, below the so-called waxing temperature, the long-chain alkane molecules will solidify. Above the waxing temperature, the polymeric mixture is a liquid phase with high viscosity that varies strongly with temperature. STWA's technology is based upon using dielectrophoresis (DEP) to stimulate aggregation that causes alkane molecules to clump together into sub-micron particulate matter. As will be discussed later, this conformational change can dramatically decrease bulk viscosity of the solution.

Asphaltenes are a general class of molecules that are not soluble in alkane-based solvents such as n-heptane, but soluble in aromatic solvents such as toluene. The actual molecular structure can vary significantly depending upon the crude oil source. An example of an asphaltene molecule from Venezuelan crude is shown in FIG. 2. These types of molecules consist of many aromatic ring-type moieties, thereby giving them a somewhat two-dimensional structure, which allows them to be soluble in toluene-type solvents.

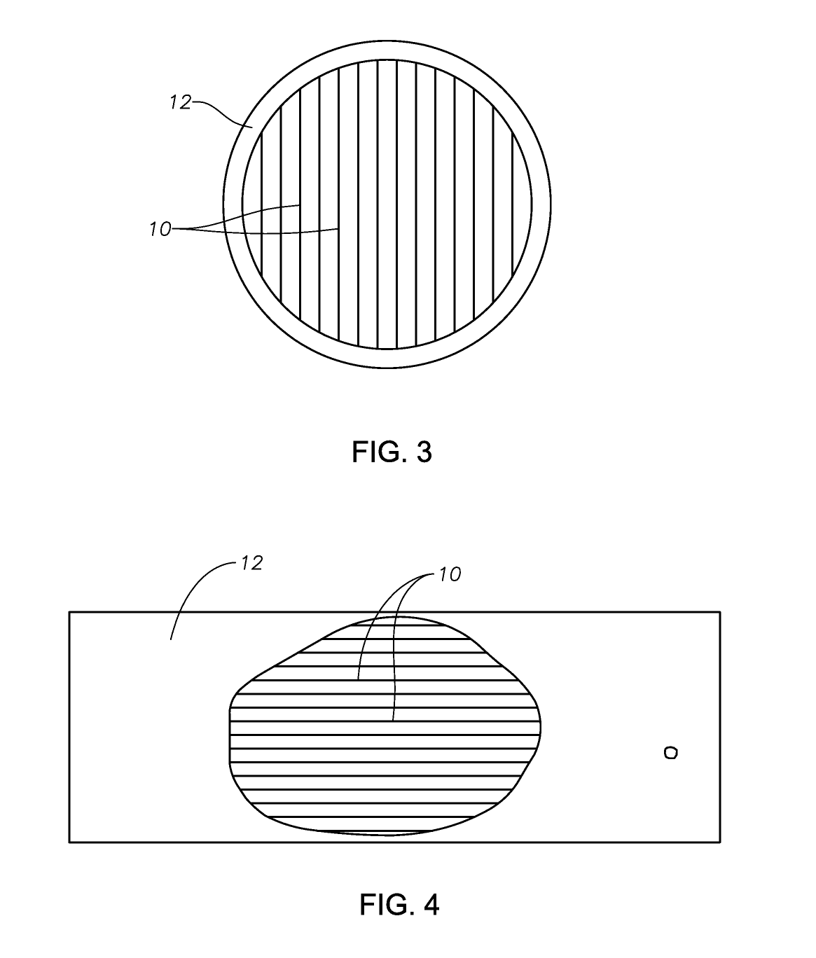

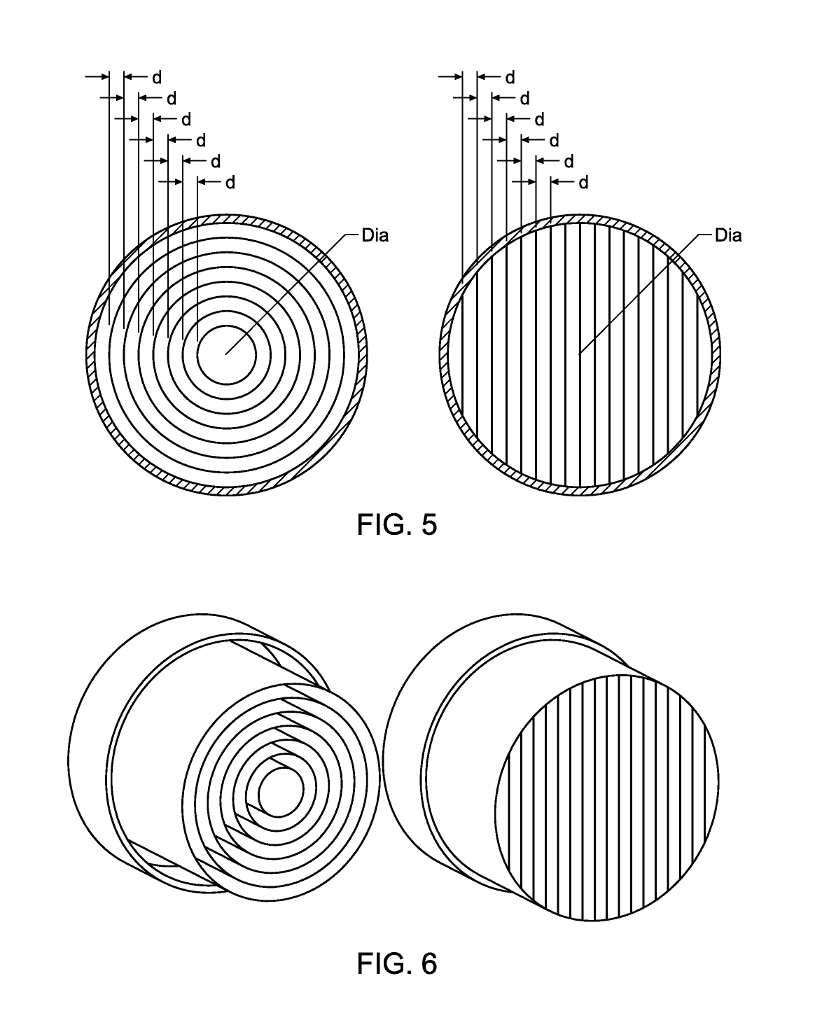

As can be seen from FIGS. 1 and 2, the structural form of paraffin and asphaltene-type molecules are significantly different. For our basic discussion, we can consider paraffin to be quasi one-dimensional, whereas asphaltene can be considered quasi two-dimensional. As these molecules migrate through an apparatus for reducing viscosity, such as seen in FIGS. 3, 4, 5, 6 (which will be discussed later in this disclosure) with an appropriate electric field, the molecules will clump into sub-micron sized particulate clusters.

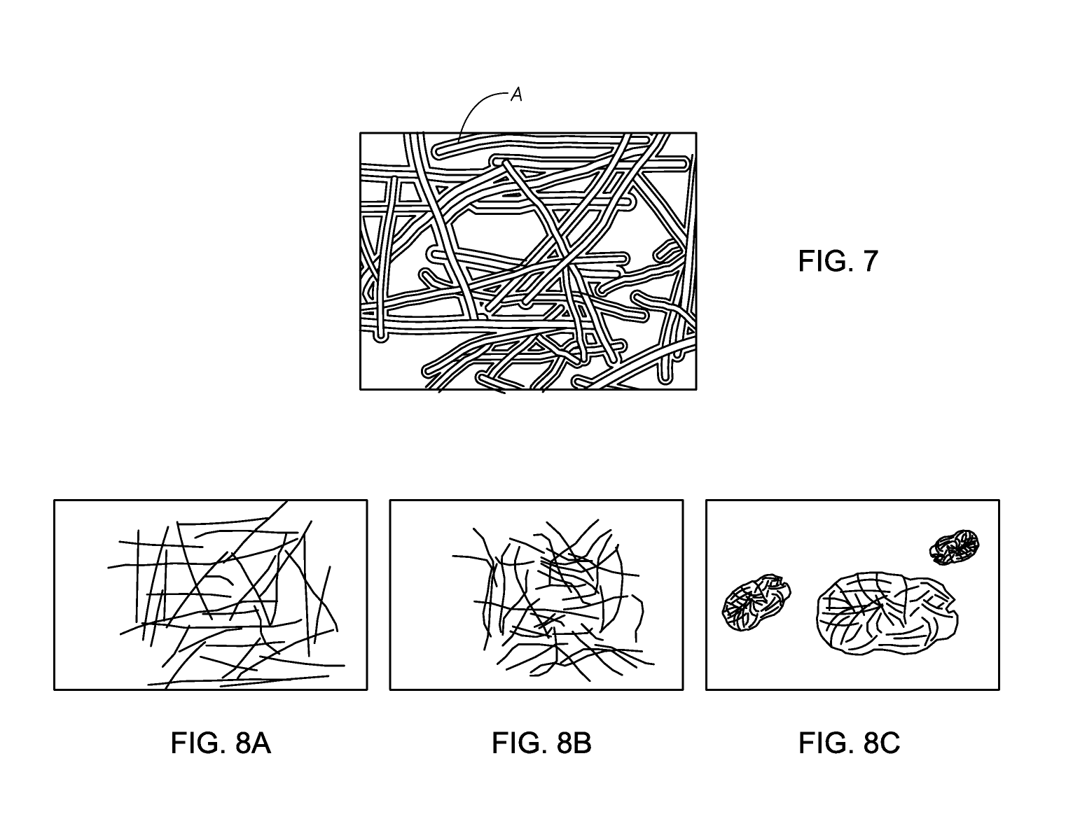

Upon the application of an appropriate electric field, molecules/particulate matter can be made to aggregate. Consider molecules/particulate matter suspended in a solvent that exhibit a different permittivity compared to the surrounding medium. Under the influence of an applied electric field, a dipole moment will be induced at the interface of the molecules/particulate matter and the surrounding medium. This is shown in FIG. 7 where region A indicates the induced dipole region surrounding paraffin-like molecules. These induced dipole moments are generated as a result of exposure to the electric field, and provide a net dielectrophoretic force that pulls the molecules/particulate matter together, thereby inducing aggregation during treatment within the apparatus. Hence, FIG. 7 is an example of paraffin molecules under the influence of an applied electric field. Region A in FIG. 7 indicates the region where induced dipoles are formed.

The attractive Coulombic force must be sufficiently high to overcome the entropic forces due to thermal energy, k_{B}T. Therefore, the critical electric field is estimated by

$${E}_{c} = \frac{{k}_{E} T}{n {ɛ}_{f} {a}^{3}} \frac{{ɛ}_{p} + 2 {ɛ}_{f}}{( {ɛ}_{p} - {ɛ}_{f} )} , \qquad ( 1 )$$

where a is the effective radius of the molecule/particulate, n is the number density of the molecule/particulate matter, and the permittivity is given ε_{P} and ε_{f} for the particle and fluid, respectively. Once the molecules have been pulled sufficiently close together, van der Waals forces can act to maintain the aggregated state. However, entropic forces will eventually cause the aggregated particles to de-aggregate, and eventually return to the initial un-aggregated state. The time scale required for reversing the aggregated state is not clear from first principals, however, based upon empirical evidence in independent laboratory testing indicates that the time scale required is in excess of 24 hours, and depends upon several factors.

Most polymeric fluids (such as crude oil) exhibit complex non-linear behavior.

It has been found that the DEP-based aggregation of molecules creates a conformational change in the structure of the particulate matter. It is this change in conformation that reduces viscosity, as per the teachings of this disclosure.

An illustration of the aggregation process for paraffin-like molecules is shown in FIGS. 8A-8C. As one can observe, initially the molecules are dispersed in the medium (FIG. 8A). This dispersion allows the molecules to dissipate energy from the flowing medium. However, when an appropriate electric field is applied, induced electric dipoles cause the molecules to aggregate. First they coalesce (FIG. 8B), and then aggregate into particulate matter (FIG. 8C). Once the molecules are aggregated into sub-micron or micron-sized particulate matter, the amount of energy that they dissipate from the flowing medium is dramatically reduced, and therefore the effective viscosity of the bulk solution is reduced.

A model for nanoaggregates of asphaltenes has been suggested. The asphaltene model has the aromatic molecules on one side of the alkane moieties which extend from the aromatic center. Essentially, asphaltenes are aromatic rings with alkane moieties that can be affected via dielectrophoresis-induced dipole moments. These alkanes interact with neighboring molecules and form nano-scale clusters due to the temporary induction of a dipole moment to the alkane moiety. As per the teachings of this disclosure, under an intense electric field as generated by the apparatus, this aggregation process can be increased; creating larger clusters and thereby decreasing the dissipation effect on the surrounding medium, which in turn reduces the effective bulk viscosity.

Referring again to FIG. 3, a front view of a disclosed embodiment is illustrated. In one embodiment, plates 10 are arranged in parallel at a predetermined, uniform 5 cm spacing. Alternatively, plates 10 are arranged in parallel at a predetermined, uniform spacing between ⅛ inches and 2 inches. Plates 10 are oppositely charged, tied together by common electrical feed. Plates 10 are contained within tubular member 12, wherein tubular member 12 may be an electrical insulator polyurethane blended insulator.

FIG. 4 is a top, partial cross-sectional view of the embodiment of FIG. 3. As noted earlier, plates 10 are arranged at a predetermined, uniform 5 cm spacing, oppositely charged, tied together by a common electrical feed. Alternatively, plates 10 are arranged at a predetermined, uniform spacing between ⅛ inches and 2 inches. Tubular member 12 may be an electrical polyurethane blended insulator.

An aspect of the parallel-plate apparatus and/or concentric cylinder-type apparatus is the streamlining of costs associated with manufacture and operation when compared to a similar apparatus with plates held perpendicular to the flow direction.

Another aspect is the current parallel plate apparatus and/or concentric cylinder-type apparatus is that by aligning the plates parallel to the bulk fluid flow, the pressure drop is minimized through the apparatus.

Yet another aspect is the parallel plate device allows for the efficient and effective reduction of viscosity in hydrocarbon fluids and gas.

A method of reducing viscosity of a hydrocarbon liquid containing paraffin molecules or asphaltene molecules in suspension may include providing a viscosity reducing apparatus. The viscosity reducing apparatus may include a conduit having an inner cavity dimensioned to accommodate a flow of the hydrocarbon liquid along a flow direction extending from an inlet end of the inner cavity to an outlet end of the inner cavity, and a series of electrically charged plates housed within the inner cavity, with each electrically charged plate extending along the flow direction. The method may further include flowing the hydrocarbon liquid through the inner cavity of the conduit, and using the series of electrically charged plates to apply electric fields to the hydrocarbon liquid flowing through the inner cavity such that a plurality of paraffin molecules or a plurality of asphaltene molecules undergo a conformational change in microstructure to form a cluster of paraffin molecules or a cluster of asphaltene molecules, thereby reducing the viscosity of the hydrocarbon liquid.

Where the hydrocarbon liquid contains paraffin molecules and asphaltene molecules in suspension, the method may include using the series of electrically charged plates to apply electric fields to the hydrocarbon liquid flowing through the inner cavity such that a plurality of paraffin molecules and a plurality of asphaltene molecules undergo a conformational change in microstructure to form a cluster of paraffin molecules and a cluster of asphaltene molecules, thereby reducing the viscosity of the hydrocarbon liquid.

The strength of the applied electric field may be varied to achieve a desired viscosity reduction of the hydrocarbon liquid. Alternatively, the exposure time period of the hydrocarbon liquid to the applied electric field may be varied to achieve a desired viscosity reduction of the hydrocarbon liquid. In another alternative, the strength of the applied electric field and the exposure time period of the hydrocarbon liquid to the applied electric field may both be varied to achieve a desired viscosity reduction of the hydrocarbon liquid.

The series of electrically charged plates may be concentrically arranged, and the method may include flowing the hydrocarbon liquid between each of the series of electrically charged plates in the inner cavity of the conduit. In a further embodiment, the inner cavity of the conduit and each electrically charged plate may be cylindrically-shaped, with the electrically charged plates concentrically arranged within the inner cavity, and the method may include flowing the hydrocarbon liquid between each of the series of electrically charged plates in the inner cavity of the conduit. Alternatively, the series of electrically charged plates may be configured in a parallel arrangement, and the method may include flowing the hydrocarbon liquid between each of the series of electrically charged plates in the inner cavity of the conduit.

Although the present invention has been described in considerable detail with reference to certain preferred versions thereof, other versions are possible. Therefore, the spirit and scope of the appended claims should not be limited to the description of the preferred versions contained herein.

I claim:

1. A method of reducing the viscosity of a hydrocarbon liquid containing paraffin molecules in suspension, the method comprising:
a) providing a conduit having an inner cavity dimensioned to accommodate a flow of the hydrocarbon liquid;
b) flowing the hydrocarbon liquid through the inner cavity of the conduit;
c) applying an electric field to the hydrocarbon liquid flowing through the inner cavity such that a plurality of paraffin molecules undergo a conformational change in microstructure to form a cluster of paraffin molecules, thereby reducing the viscosity of the hydrocarbon liquid.

2. The method of claim 1, wherein step (c) comprises varying a strength of the applied electric field to achieve a desired viscosity reduction of the hydrocarbon liquid.

3. The method of claim 1, wherein step (c) comprises varying an exposure time period of the hydrocarbon liquid to the applied electric field to achieve a desired viscosity reduction of the hydrocarbon liquid.

4. The method of claim 1, wherein step (c) comprises varying a strength of the applied electric field and varying an exposure time period of the hydrocarbon liquid to the applied electric field to achieve a desired viscosity reduction of the hydrocarbon liquid.

5. The method of claim 1, wherein the hydrocarbon liquid contains paraffin molecules and asphaltene molecules in suspension, and wherein step (c) comprises:
applying an electric field to the hydrocarbon liquid flowing through the inner cavity such that a plurality of paraffin molecules and a plurality of asphaltene molecules undergo a conformational change in microstructure to form a cluster of paraffin molecules and a cluster of asphaltene molecules, thereby reducing the viscosity of the hydrocarbon liquid.

6. The method of claim 1, wherein step (c) further comprises:
flowing the hydrocarbon liquid through a series of electrically charged plates housed in a parallel arrangement within the inner cavity of the conduit, and using the series of electrically charged plates to apply an electric field to the hydrocarbon liquid.

7. The method of claim 1, wherein step (c) further comprises:
flowing the hydrocarbon liquid through a series of electrically charged plates housed in a concentric arrangement within the inner cavity of the conduit, and using the series of electrically charged plates to apply an electric field to the hydrocarbon liquid.

8. The method of claim 1, wherein the electric field is at least:
$${E}_{c} = \frac{{k}_{E} T}{n {ɛ}_{f} {a}^{3}} \frac{{ɛ}_{p} + 2 {ɛ}_{f}}{( {ɛ}_{p} - {ɛ}_{f} )} ,$$
where a is the effective radius of the molecule/particulate, n is the number density of the molecule/particulate matter, and the permittivity is given ε_{P} and ε_{f} for the particle and fluid, respectively.

9. A method of reducing the viscosity of a hydrocarbon liquid containing asphaltene molecules in suspension, the method comprising:
a) providing a conduit having an inner cavity dimensioned to accommodate a flow of the hydrocarbon liquid;
b) flowing the hydrocarbon liquid through the inner cavity of the conduit;
c) applying an electric field to the hydrocarbon liquid flowing through the inner cavity such that a plurality of asphaltene molecules undergo a conformational change in microstructure to form a cluster of asphaltene molecules, thereby reducing the viscosity of the hydrocarbon liquid.

10. The method of claim 9, wherein step (c) comprises varying a strength of the applied electric field to achieve a desired viscosity reduction of the hydrocarbon liquid.

11. The method of claim 9, wherein step (c) comprises varying an exposure time period of the hydrocarbon liquid to the applied electric field to achieve a desired viscosity reduction of the hydrocarbon liquid.

12. The method of claim 9, wherein step (c) comprises varying a strength of the applied electric field and varying an exposure time period of the hydrocarbon liquid to the applied electric field to achieve a desired viscosity reduction of the hydrocarbon liquid.

13. The method of claim 9, wherein step (c) further comprises:
flowing the hydrocarbon liquid through a series of electrically charged plates housed in a parallel arrangement within the inner cavity of the conduit, and using the series of electrically charged plates to apply an electric field to the hydrocarbon liquid.

14. The method of claim 9, wherein step (c) further comprises:
flowing the hydrocarbon liquid through a series of electrically charged plates housed in a concentric arrangement within the inner cavity of the conduit, and using the series of electrically charged plates to apply an electric field to the hydrocarbon liquid.

15. The method of claim 9, wherein the electric field is at least:
$${E}_{c} = \frac{{k}_{E} T}{n {ɛ}_{f} {a}^{3}} \frac{{ɛ}_{p} + 2 {ɛ}_{f}}{( {ɛ}_{p} - {ɛ}_{f} )} ,$$
where a is the effective radius of the molecule/particulate, n is the number density of the molecule/particulate matter, and the permittivity is given ε_{P} and ε_{f} for the particle and fluid, respectively.

16. An apparatus for reducing the viscosity of a hydrocarbon liquid containing paraffin molecules or asphaltene molecules in suspension, comprising:
a conduit having an inner cavity dimensioned to accommodate a flow of the hydrocarbon liquid along a flow direction extending from an inlet end of the inner cavity to an outlet end of the inner cavity
a series of electrically charged plates housed within the inner cavity, wherein a longitudinal axis of each electrically charged plate extends along the flow direction.

17. The apparatus of claim 16, wherein the series of electrically charged plates are concentrically arranged.

18. The apparatus of claim 16, wherein the series of electrically charged plates are configured in a parallel arrangement.

19. The apparatus of claim 16, wherein the series of electrically charged plates are alternately charged.

20. The apparatus of claim 16, wherein the conduit comprises a polyurethane material.
